(19) United States
(12) Patent Application Publication
(10) Pub. No.: US 2023/0257659 A1
(43) Pub. Date: Aug. 17, 2023

(54) BIO-CRUDE YIELDS, PROPERTIES AND PROCESSABILITY OF HYDROTHERMAL LIQUEFACTION FEEDSTOCKS USING YELLOW GREASE

(71) Applicant: NATIONAL RESEARCH COUNCIL OF CANADA, Ottawa (CA)

(72) Inventors: Devinder SINGH, Stittsville (CA); Gilles P. ROBERTSON, Gatineau (CA)

(21) Appl. No.: 17/920,968

(22) PCT Filed: Apr. 28, 2021
(86) PCT No.: PCT/IB2021/053511

§ 371 Date: Oct. 24, 2022

Related U.S. Application Data
(60) Provisional application No. 63/016,632, filed on Apr. 28, 2020.

(51) Int. Cl. C10G 1/00

(52) U.S. Cl. CPC C10G 1/008; C10G 2300/1003; C10G 2300/1011; C10G 2300/206; C10G 2300/302

(57) ABSTRACT

An example system for co-liquefying feedstock and yellow grease includes: a feedstock container to contain a feedstock; a yellow grease container to contain a yellow grease; a hydrothermal liquefaction system configured to receive feedstock from the feedstock container and to receive yellow grease from the yellow grease container; the feedstock received by the hydrothermal liquefaction system and the yellow grease received by the hydrothermal liquefaction system to become a mixture; a controller connected to the feedstock container and the yellow grease container, the controller configured to control the amount of the feedstock supplied from the feedstock container to the hydrothermal liquefaction system, the controller further configured to control the amount of the yellow grease supplied from the yellow grease container to the hydrothermal liquefaction system to be between 10% to 50% of the mixture; and a collector configured to receive a bio-crude from the hydrothermal liquefaction system.

### FIELD OF INVENTION

The present disclosure relates generally to increasing bio-crude yields and improving properties of bio-crude obtained through hydrothermal liquefaction, and more particularly to increasing bio-crude yields and improving properties by adding yellow grease before hydrothermal liquefaction process.

### BACKGROUND

Hydrothermal liquefaction can convert feedstocks into bio-crude, which in turn can be upgraded to liquid biofuel like greendiesel, biojet fuel etc. Some problems associated with this process are difficulty in processing of high solid feedstocks, and effectiveness of the hydrothermal liquefaction conversion from feedstock into bio-crude. A higher yield and better quality of bio-crude directly affects the ease and efficiency of converting bio-crude into liquid biofuel and improves the overall economics of the process.

### SUMMARY

According to an aspect of the present disclosure, a system for co-liquefying feedstock and yellow grease is provided. The system includes: a feedstock container to contain a feedstock; a yellow grease container to contain a yellow grease; a hydrothermal liquefaction system that receives feedstock from the feedstock container and receives yellow grease from the yellow grease container, the feedstock and yellow grease to further become a mixture in specific ratios; a controller connected to the feedstock container and yellow grease container, the controller to further control the amount of feedstock to be supplied from the feedstock container to the hydrothermal liquefaction system, the controller to further control the amount of yellow grease to be supplied from the yellow grease container to the hydrothermal liquefaction system to be between 10% to 50% of the mixture; the HTL reactor system and a collector to receive and collect bio-crude from the hydrothermal liquefaction system.

According to another aspect of the present disclosure, a method for co-liquefying feedstock and yellow grease, the method includes: receiving a feedstock by a hydrothermal liquefaction system from a feedstock container; receiving a yellow grease by the hydrothermal liquefaction system from a yellow grease container, where the amount of yellow grease received is to be between 10% and 50% of the mixture of feedstock and yellow grease; and co-liquefying the mixture into a bio-crude.

### BRIEF DESCRIPTION OF THE DRAWINGS

FIG. 1 is a block diagram of an example system for co-liquefying feedstock and yellow grease.

FIG. 2 is a flowchart of an example method of operation of the system for co-liquefying feedstock and yellow grease in FIG. 1.

FIG. 3 depicts a comparison of bio-crude yield when co-liquefying food waste and yellow grease in different ratios.

FIG. 4 depicts a comparison and a forecast of theoretical bio-crude yields and observed bio-crude yields when co-liquefying food waste and yellow grease.

FIG. 5 depicts a comparison of asphaltene content in bio-crude when co-liquefying food waste and yellow grease in different ratios.

FIG. 6 depicts a comparison of aromatic content in bio-crude when co-liquefying food waste and yellow grease in different ratios.

FIG. 7 depicts a comparison of viscosity in bio-crude when co-liquefying food waste and yellow grease in different ratios.

FIG. 8 depicts a sample chemical composition of bio-crude when co-liquefying a mixture of 75% food waste and 25% yellow grease.

### DETAILED DESCRIPTION

Hydrothermal liquefaction (“HTL”) is useful in the conversion of low value wet feedstocks to bio-crude. Bio-crude is useful as it can be converted into liquid biofuel which can be used as fuel for transportation. In order to make HTL economically and environmentally feasible, the yield of bio-crude and quality of bio-crude generated from the HTL process is important. In addition, the yield and quality of the bio-crude is directly related to the ease of upgrading to a liquid biofuel. By being able to increase the yield and quality of the bio-crude generated from HTL, upgrading of HTL bio-crude to a liquid biofuel (green diesel, biojet, renewable gasoline, etc.) is expected to become easier, more efficient, and economical.

Currently, there are many ways of increasing bio-crude yields and quality, including using additives and catalysts. However, long term usability of catalysts are not proven, and the low quality of the feedstocks could impact catalyst life. In addition, use of catalysts and additives adds to the cost of the entire process. If solvents need to be recovered or recycled, this further adds to the cost of the entire process.

The present disclosure provides a method and a system that uses HTL to co-liquify feedstock and yellow grease to increase the yield (beyond what is obtained by processing these feedstocks separately) and quality of bio-crude.

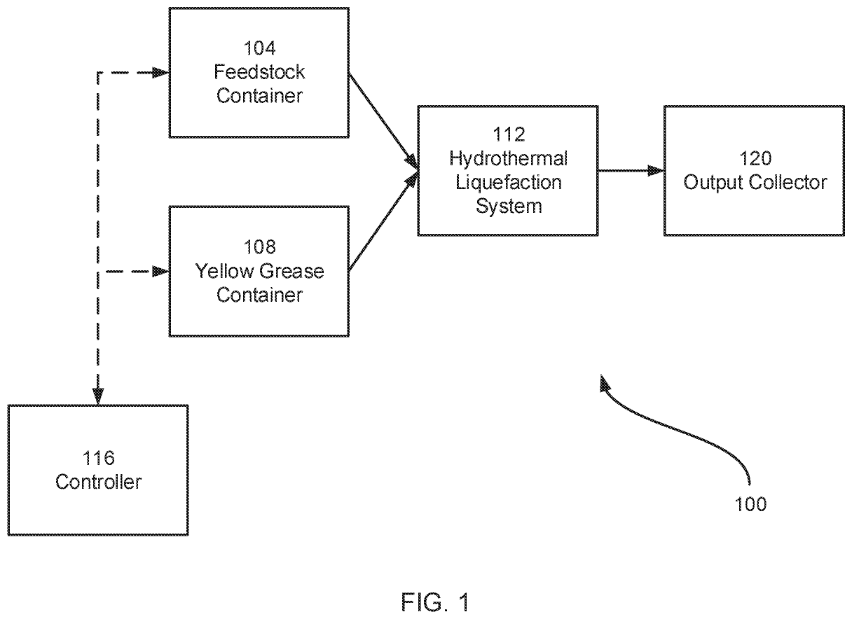

FIG. 1 depicts an example system 100 for converting feedstock and yellow grease into bio-crude. System 100 includes a feedstock container 104, yellow grease container 108, hydrothermal liquefaction system 112, controller 116 and collector 120.

Feedstock container 104 includes feedstock. Feedstock can be any biomass that can be converted into bio-crude using HTL. Examples of feedstock include agriculture residues, fermentation residues, sludges, such as sewer sludges and algae, such as low lipid algae. In the current embodiment, feedstock is food waste. Other examples of feedstock may also be contained in feedstock container 104. Feedstock in feedstock container 104 may also be a composition or a mixture of multiple types of feedstock, and is not limited to a homogenous type of feedstock. Feedstock may also have different measurable qualities, including ash content, water content and viscosity.

Yellow grease container 108 includes yellow grease. Yellow grease may be any used vegetable oil, used cooking oil, or recycled vegetable oil. Typically, yellow grease comes from frying oils from deep fryers. Other forms of yellow grease include tallow, such as cow or sheep fat. Yellow grease may also be a mixture of animal fats and oils.

Feedstock container 104 and yellow grease container 108 both feed hydrothermal liquefaction system 112 with feedstock and yellow grease respectively. Feedstock and yellow grease can reach the intake of hydrothermal liquefaction system 112 through a feeding assembly. Examples of feeding assemblies may include pipes, pumps, and conveyor belts. Both feedstock and yellow grease get mixed into a mixture in hydrothermal liquefaction system 112.

In other embodiments, feedstock and yellow grease may be fed into a mixer to be mixed into a mixture prior to being sent to hydrothermal liquefaction system 112.

Hydrothermal liquefaction system 112 uses the HTL process on the received feedstock and yellow grease mixture. The HTL process is a thermal depolymerization process that converts the mixture into bio-crude. In the present example, temperature and pressure are used in the HTL process to co-liquefy the feedstock and yellow grease mixture into a high yield and high quality bio-crude. In addition, in the present example, the feedstock used in the HTL process is a food waste with a water content of 85 wt (%) and an ash content of 4% wt (%).

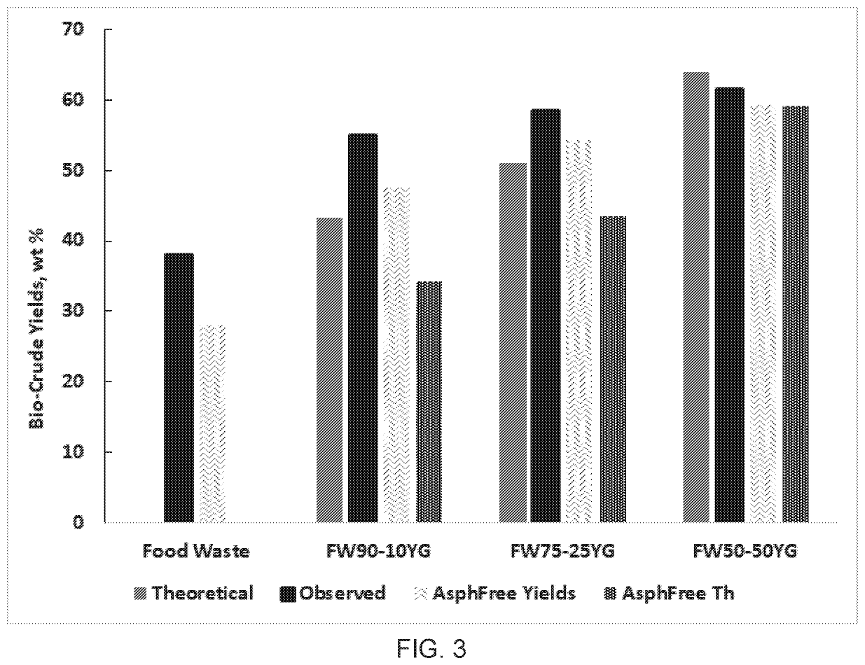

Temperatures for the HTL process may range between 250° C. to 375° C. Pressure used in the HTL process may range between 580 psig to 3200 psig. In the current example, and in the below observations in FIGS. 3-8, the conditions used in the HTL process to co-liquefy the feedstock and yellow grease mixture are a 350° C. temperature and a pressure between 2800 and 2900 psig. Additionally, at the aforementioned example conditions, the residence time of HTL process may be 30 minutes.

As mentioned above, using additives in the HTL process may increase bio-crude yields. Examples of additives used in the HTL process include alkalis, including, but not limited to, NaOH, KOH, sodium bicarbonate, and potassium bicarbonate. In the current example, and in the below observations in FIGS. 3-8, 1 wt(%) of sodium bicarbonate is added to the mixture.

The HTL process involves a variety of reactions, including hydrolysis depolymerization, decarboxylation, condensation, deamination, re-polymerization of the aromatics, polycyclics and interactions of intermediates from these reactions to form higher molecular weight compounds of char, producing a range of molecules in terms of function groups and size. Depending on the concentration of various organic species produced during the HTL process, their solubility in the water phase and the equilibrium established between the oil phase (bio-crude) and the aqueous (water) phase, organics either end up in the oil/bio-crude phase (forming part of the product) or the aqueous phase (representing a loss of product). As such, the addition of yellow grease may influence desirable reactions, and also act as a solvent to produce a higher quantity of bio-crude and better quality of bio-crude (lower asphaltenes, aromatics, etc.).

Controller 116 is connected to feedstock container 104, and yellow grease container 108 and controls the amount of feedstock and amount of yellow grease that is supplied to hydrothermal liquefaction system 112. Controller 116 may be a series of sensors, coupled to a communications interface, a memory and a processor. In the current embodiment, controller 116 is configured to measure the amount of feedstock being fed to hydrothermal liquefaction system 112 and then formulate the amount of yellow grease to be fed to hydrothermal liquefaction system 112 based off of a ratio of yellow grease to feedstock. The ratio of yellow grease to feedstock will be discussed further below.

In other embodiments, controller 116 may also be able to detect the type of feedstock or quality of feedstock in feedstock container 104, and adjust the amount of yellow grease to be sent to hydrothermal liquefaction system 112 according to the type or quality of feedstock detected.

Bio-crude is then collected by collector 120 to be further converted into liquid bio-fuel or other products in the future.

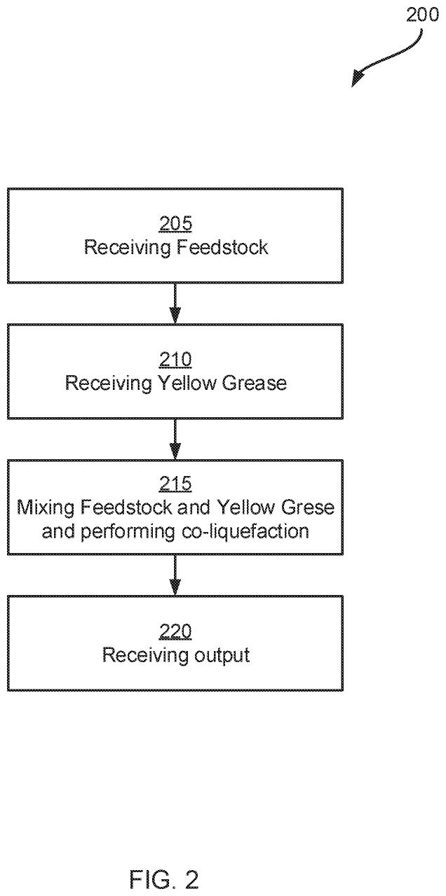

Referring now to FIG. 2, an example method 200 for converting feedstock and yellow grease into bio-crude is depicted. Method 200 will be described in conjunction with its performance in system 100. In other examples, method 200 may be performed by other suitable systems.

At block 205, feedstock is received by hydrothermal liquefaction system 112 from feedstock container 104. At block 210, yellow grease is received by hydrothermal liquefaction system 112 from yellow grease container 108. Block 205 and block 210 can happen sequentially, one after another, or they can occur in parallel, with both the feedstock being received at the same time as the yellow grease is being received by hydrothermal liquefaction system 112. In the current embodiment, food waste is the feedstock and is received by hydrothermal liquefaction system 112, and yellow grease is received by hydrothermal liquefaction system 112 shortly afterwards.

The amount of yellow grease and feedstock received by hydrothermal liquefaction system 112 is controlled by controller 116. As indicated above, controller 116 will determine the amount of yellow grease to be fed to hydrothermal liquefaction system 112 based off a ratio of yellow grease to feedstock. The ratio of yellow grease to feedstock will be discussed further below.

At block 215, the feedstock and yellow grease is mixed in hydrothermal liquefaction system 112 and then the mixture is co-liquefied. This is performed using a combination of temperature and pressure. Once co-liquefaction is complete, the resulting bio-crude is then collected at block 220.

The ratio of yellow grease to feedstock may vary, and is outlined in experiments further below. The experiments determined that the yellow grease amount to be received by hydrothermal liquefaction system 112 is advantageous between 10% to 50% of the mixture of feedstock and yellow grease.

An advantage of using yellow grease and feedstock together is that when performing co-liquefaction, the resulting bio-crude has a higher yield and is of a higher quality. As indicated in Table 1 below, experiments were performed within a range of ratios of yellow grease to food waste, where four tests were done. The first was a control test, where food waste alone went through the HTL process. The second test was a mixture with a ratio of 10% yellow grease to 90% food waste. The third test was a mixture with a ratio of 25% yellow grease to 75% food waste (based on dry weight percent). The fourth test was a mixture with a ratio of 50% yellow grease to 50% food waste. As can be seen below, the observed yields of bio-crude surpassed that of the theoretical yields that were estimated if these feedstocks were to be processed separately. Theoretical yields were calculated as the weighted average of bio-crude yields of food waste and yellow grease if processed separately, where food waste is at 38% and yellow grease at 90%.

TABLE 1
Experiment of Yields of Bio-Crude from Co-liquefaction of
Food Waste and Yellow Grease Mixtures

| | Theoretical | Observed |
|---|---|---|
| Mixture | Yields, wt (%) | Yields, wt (%) |
| Food Waste 100% | 38.0 | 38.0 |
| Yellow Grease 0% | | |
| Food Waste 90% | 43.2 | 55.0 |
| Yellow Grease 10% | | |
| Food Waste 75% | 51.0 | 58.5 |
| Yellow Grease 25% | | |
| Food Waste 50% | 64 | 61.6 |
| Yellow Grease 50% | | |

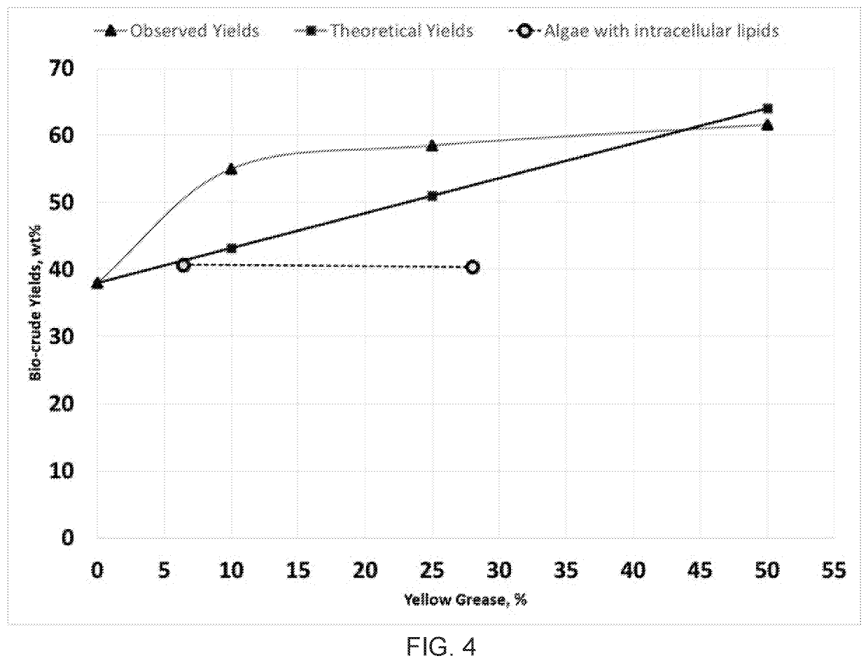

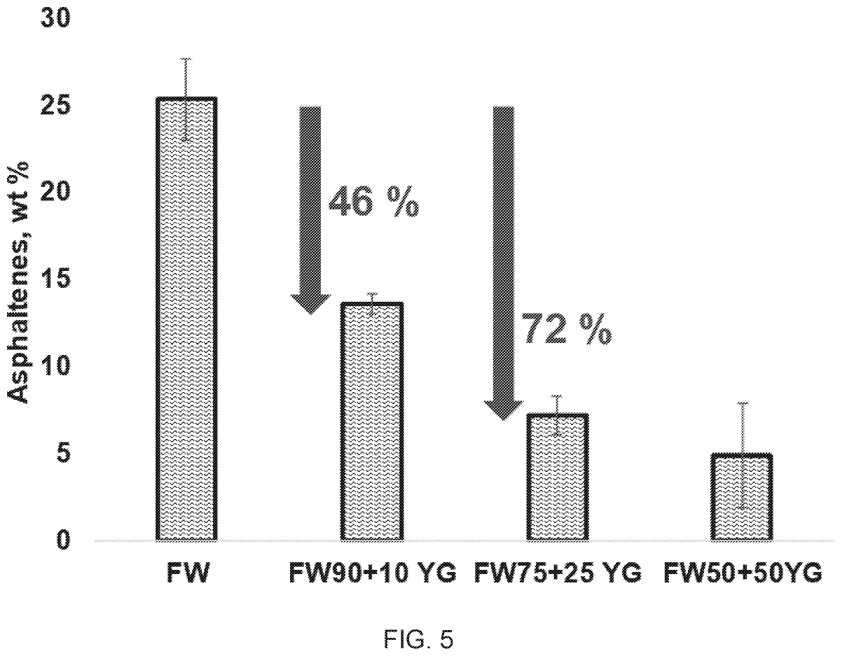

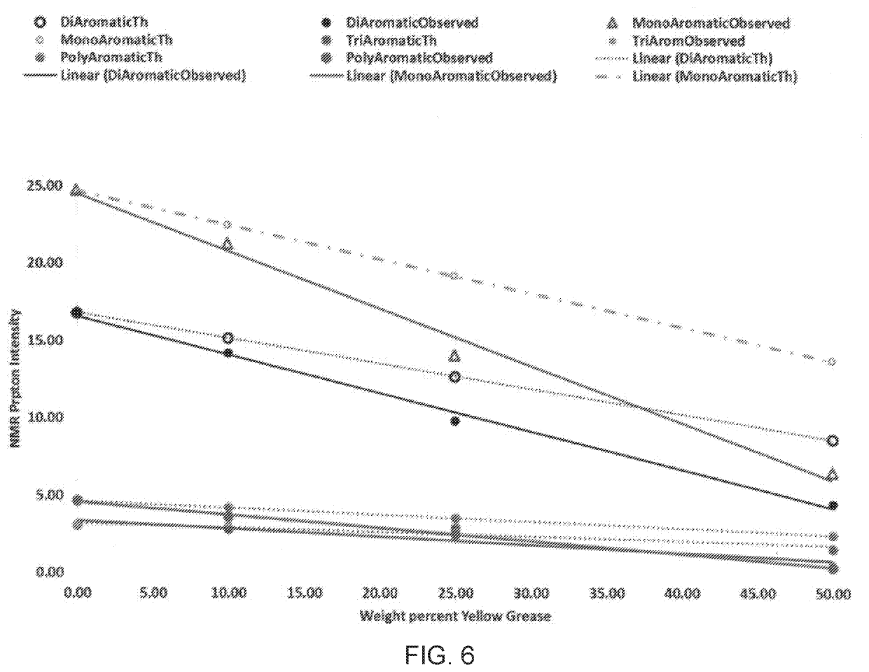

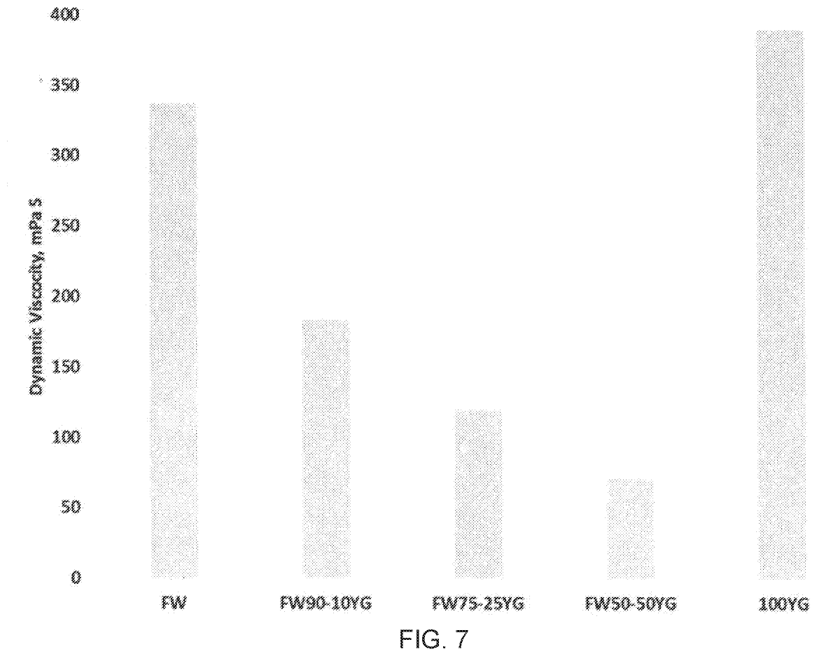

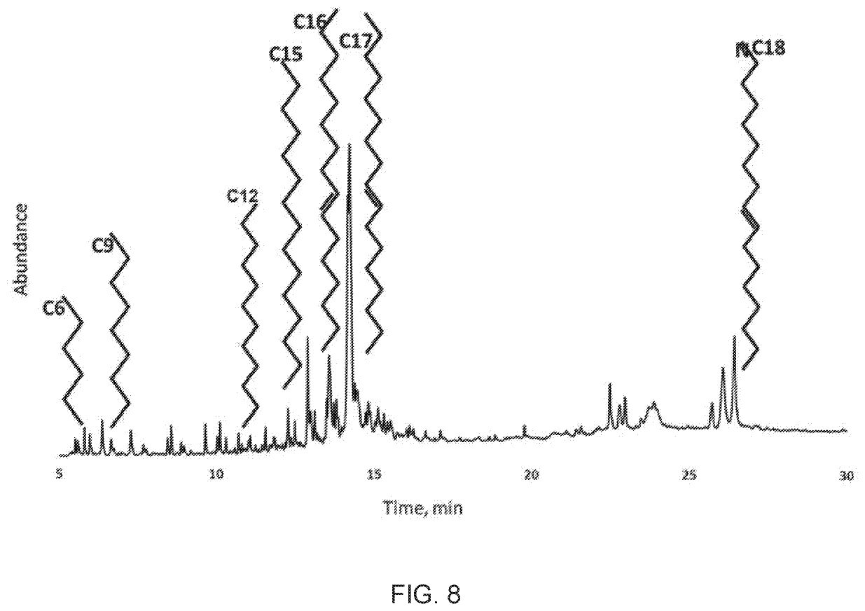

Referring now to FIG. 3, the results of Table 1 are graphed, and as can be seen, the observed yields are greater than the theoretical yields. For clarity, FIG. 3, FIG. 4, FIG. 5, FIG. 6, FIG. 7 and FIG. 8 may contain abbreviations. FW may be used for food waste, and YG may be used for yellow grease.

With a ratio of 10% yellow grease to 90% food waste, the observed yields were 27% to 30% greater than those of the theoretical yields.

With a ratio of 25% yellow grease to 75% food waste, the observed yields were 15% to 20% greater than those of the theoretical yields.

With a ratio of 50% yellow grease to 50% food waste, the observed yields were around 4% less than those of the theoretical yields.

Referring now to FIG. 4, the results of Table 1 are plotted, and a forecast is provided. When analyzing the results of the forecast, or trendline, a ratio of 25% yellow grease to 75% food waste provides the optimum bio-crude yields in relation to maximizing the effect of yellow grease in the mixture.

Another possible advantage of blending yellow grease with feedstocks is that it is expected to improve the pumping characteristics of the mixed feedstock.

Another possible advantage of blending yellow grease with feedstocks is that it is expected to improve the lubricity of the end product.

Another advantage of using yellow grease and feedstock together is that when performing co-liquefaction, the resulting bio-crude has fewer asphaltenes. Asphaltenes are a class that are generally characterized by high molecular weights and aromaticity containing multiple islands of polynuclear aromatics of four or larger aromatic rings. Asphaltenes are undesirable in bio-crude as they tend to precipitate causing fouling issues, energy losses in heat exchangers, excessive coking and irreversible catalyst poisoning.

In addition, minimizing asphaltenes is desirable as it would result in increasing liquid yields of end products, improving the economics of the overall process. Furthermore, additional processes of minimizing asphaltenes may include separation through solvent extraction, but may increase the cost of achieving the desired asphaltene content result.

As can be seen below in Table 2, with the same four ratios of yellow grease to food waste, there was a decline of asphaltenes as the amount of yellow grease increased in the yellow grease to good waste ratio.

TABLE 2
Asphaltene Content for different mixtures of food waste and yellow grease

| Mixture (dry wt %) | Asphaltene Content, wt (%) |
|---|---|
| Food Waste 100% | 25.3 |
| Yellow Grease 0% | |
| Food Waste 90% | 13.6 |
| Yellow Grease 10% | |
| Food Waste 75% | 7.2 |
| Yellow Grease 25% | |
| Food Waste 50% | 4.9 |
| Yellow Grease 50% | |

Referring now to FIG. 5, the results of Table 2 are graphed, and as can be seen, the asphaltene content is significantly decreased with the increased amount of yellow grease in the yellow grease and food waste mixture.

With a ratio of 10% yellow grease to 90% food waste, there is a 46% decrease in asphaltenes from the control group of 100% food waste.

With a ratio of 25% yellow grease to 75% food waste, there is a 72% decrease in asphaltenes from the control group of 100% food waste.

Other compounds have not shown the same effectiveness of decreasing asphaltenes as the addition of yellow grease. For example, the mixture of 72% feedstock, specifically algae, and 28% intracellular lipids produces 20 wt(%) of asphaltene content, which is significantly more than 7.2 wt (%) of asphaltene content in the similar ratio of 25% yellow grease to 75% food waste.

Another advantage of using yellow grease and feedstock together is that when performing co-liquefaction, the resulting bio-crude has fewer aromatics (mono, di, tri, and poly), thereby improving the overall quality of the bio-crude. Fewer aromatics also lead to a reduction in undesirable components, such as char, during the HTL process, thereby improving processability and quality of bio-crude.

Table 3 below shows the theoretical calculated and observed Nuclear magnetic resonance (“NMR”) Proton Intensity for monoaromatics, diaromatics, triaromatics and polyaromatics. As can be seen, the increase in yellow grease in the yellow grease to food waste mixture decreases the amount of aromatics. In addition, overall the NMR proton intensity in the observed aromatics were generally lower than the NMR proton intensity in the theoretical calculate amounts of aromatics.

For clarity, the following abbreviations have been used in Table 3. PolyAr stands for polyaromatics. TriAr stands for triaromatics. DiAr stands for diaromatics. MonoAr stans for monoaromatics. Th stands for theoretical. Obs stans for observed.

TABLE 3
NMR Proton Intensity of Aromatics for mixtures of food waste and yellow grease

| | NMR Proton Intensity | | | | | | | |
|---|---|---|---|---|---|---|---|---|
| | PolyAr | PolyAr | TriAr | TriAr | DiAr | DiAr | MonoAr | MonoAr |
| Mixture | Th. | Obs | Th | Obs | Th | Obs | Th | Obs |
| Food Waste 100% | 4.7 | 4.7 | 3.1 | 3.1 | 16.8 | 16.81 | 24.7 | 24.7 |
| Yellow Grease 0% | | | | | | | | |
| Food Waste 90% | 4.3 | 3.7 | 2.8 | 3.1 | 15.2 | 14.23 | 22.5 | 21.3 |
| Yellow Grease 10% | | | | | | | | |
| Food Waste 75% | 3.6 | 2.6 | 2.9 | 2.2 | 12.7 | 9.82 | 19.2 | 14.1 |
| Yellow Grease 25% | | | | | | | | |
| Food Waste 50% | 2.5 | 0.4 | 1.6 | 0.6 | 8.6 | 4.48 | 13.7 | 6.5 |
| Yellow Grease 50% | | | | | | | | |

Referring now to FIG. 6, the results of Table 3 are graphed, and as can be seen there is a decrease in all aromatics with the increased amount of yellow grease in the yellow grease and food waste mixture. In addition, the observed NMR proton intensity amounts were generally lower than the theoretical NMR proton intensity amounts.

Another advantage of using yellow grease and feedstock together is that when performing co-liquefaction, the resulting bio-crude has a lower viscosity. Lower viscosities are desired for improved pumping, and for better separation of the bio-crude from the aqueous phase and solids.

Table 4 below shows the viscosities of the resulting bio-crude. As can be seen the mixture of yellow grease and food waste decreases viscosity.

TABLE 4
Viscosities of Bio-Crude from mixture of yellow grease and food waste

| Mixture | Viscosity, mPa · S |
|---|---|
| Food Waste 100% | 337.9 |
| Yellow Grease 0% | |
| Food Waste 90% | 183.89 |
| Yellow Grease 10% | |
| Food Waste 75% | 119.79 |
| Yellow Grease 25% | |
| Food Waste 50% | 71.82 |
| Yellow Grease 50% | |
| Food Waste 0% | 390.58 |
| Yellow Grease 100% | |

Referring now to FIG. 7, the results of Table 4 are graphed, and as can be seen there is a decrease in viscosity in the resulting bio-crude from the liquefaction of the mixture of yellow grease and food waste.

Referring now to FIG. 8, the gas chromatography-mass spectrometry (“GC-MS”) profile of one of the fractions of bio-crude obtained from a yellow grease and feedstock mixture of 25% yellow grease, and 75% food waste. The yellow grease in the mixture is upgraded within the HTL process without the use of any additional supply of hydrogen or catalysts as would be required for hydrotreating of yellow grease to produce green diesel. There is no recovery or recycling of yellow grease required.

As previously mentioned, a ratio of 25% yellow grease to 75% food waste provides the optimum bio-crude yields in relation to maximizing the effect of yellow grease in the mixture. However, when taking into consideration the other properties of the output, including the aforementioned viscosity, aromatics, asphaltene levels, lubricity and char levels, the optimum ratio is 45% yellow grease to 55% food waste to obtain a high quality of bio-crude, while maintaining high bio-crude yields.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A system for co-liquefying feedstock and yellow grease, the system comprising:
a feedstock container to contain a feedstock;
a yellow grease container to contain a yellow grease;
a hydrothermal liquefaction system configured to receive, mix the feedstock and the yellow grease to become a mixture, and co-liquefy the mixture;
a controller connected to the feedstock container and the yellow grease container, the controller configured to control an amount of feedstock and an amount of yellow grease received by the hydrothermal liquefaction system, such that the amount of yellow grease is between about 10% to about 50% of the mixture; and
a collector configured to receive a bio-crude from the hydrothermal liquefaction system.

2. The system of claim 1, wherein the controller is further configured to detect at least one of composition or quality of the feedstock, and adjust the amount of the yellow grease supplied to the hydrothermal liquefaction system.

3. The system of claim 1, wherein the controller is further configured to control the amount of yellow grease supplied to the hydrothermal liquefaction system to be between about 10% to about 25% of the mixture.

4. The system of claim 1, wherein the controller is further configured to control the amount of yellow grease supplied to the hydrothermal liquefaction system to be between about 25% to about 50% of the mixture.

5. The system of claim 1, wherein the hydrothermal liquefaction system is configured to receive the mixture via a mixer; the mixer configured to mix the feedstock from the feedstock container and the yellow grease from the yellow grease container into the mixture.

6. The system of claim 1, wherein the feedstock comprises of at least one of the following: food waste, agriculture residues, fermentation residues, sewer sludges, and low lipid algae.

7. The system of claim 2, wherein the quality of the feedstock comprises of at least one of the following: water content of the feedstock, ash content of the feedstock and viscosity of the feedstock.

8. The system of claim 1, wherein the bio-crude from the hydrothermal liquefaction system has a viscosity between 71.82 mPa·s and 183.89 mPa·S.

9. The system of claim 1, wherein the bio-crude from the hydrothermal liquefaction system has an asphaltene content between 4.9 wt (%) and 13.6 wt (%).

10. The system of claim 1, wherein a resultant yield of the bio-crude from the hydrothermal liquefaction system is between 55 wt (%) and 61.6 wt (%).

11. The system of claim 1, wherein the controller is further configured to control the amount of yellow grease supplied to the hydrothermal liquefaction system to be 25% of the mixture, and the collector to receive a resultant yield of the bio-crude of 58.5 wt (%).

12. A method for co-liquefying feedstock and yellow grease, the method comprising:
receiving a feedstock by a hydrothermal liquefaction system from a feedstock container;
receiving a yellow grease by the hydrothermal liquefaction system from a yellow grease container; a yellow grease amount received to be between about 10% to about 50% of a mixture of the feedstock and the yellow grease; and
co-liquefying the mixture into a bio-crude.

13. The method of claim 12, further comprising:
detecting at least one of a composition or a quality of the feedstock;
adjusting the yellow grease amount received according to the at least one of type or quality of the feedstock detected.

14. The method of claim 12, wherein receiving a yellow grease from a yellow grease container; the yellow grease amount received to be between about 10% to about 25% of a mixture of the feedstock and the yellow grease.

15. The method of claim 12, wherein receiving a yellow grease from a yellow grease container; the yellow grease amount received to between about 25% to about 50% of a mixture of the feedstock and the yellow grease.

16. The method of claim 12, wherein the feedstock comprises of at least one of the following: food waste, agriculture residues, fermentation residues, sewer sludges, and low lipid algae.

17. The method of claim 13, wherein the quality of the feedstock comprises of at least one of the following: water content of the feedstock, ash content of the feedstock and viscosity of the feedstock.

18. The method of claim 12, wherein the bio-crude has a viscosity between 71.82 mPa·s and 183.89 mPa·S.

19. The method of claim 12, wherein the bio-crude has an asphaltene content between 4.9 wt (%) and 13.6 wt (%).

20. The method of claim 12, wherein a resultant yield of the bio-crude is between 55 wt (%) and 61.6 wt (%).

21. The method of claim 12, wherein the yellow grease amount received is 25% of the mixture of the feedstock, and a resultant yield of the bio-crude is 58.5 wt (%).
